(19) United States
(12) Patent Application Publication
(10) Pub. No.: US 2010/0258349 A1
(43) Pub. Date: Oct. 14, 2010

(54) COAXIAL CABLE UNIT AND TRANSMISSION CIRCUIT USING THE SAME

(75) Inventors: Yoshinobu SUGIHARA, Tokyo (JP); Wataru ITO, Tokyo (JP)

Correspondence Address: SUGHRUE-265550, 2100 PENNSYLVANIA AVE. NW, WASHINGTON, DC, 20037-3213, US

(73) Assignee: YOKOGAWA ELECTRIC CORPORATION, Musashino-shi (JP)

(21) Appl. No.: 12/579,664

(22) Filed: Oct. 15, 2009

(30) Foreign Application Priority Data
Oct. 15, 2008 (JP) P. 2008-266084

(51) Int. Cl. H02G 15/02

(52) U.S. Cl. 174/75 R

(57) ABSTRACT

A coaxial cable has a center conductor and an outer conductor, and a connector of a non-coaxial structure is attached to the center conductor and the outer conductor on an output side of the coaxial cable. A bypass wire is connected to the outer conductor at a portion, which is on an input side with respect to a position where the connector of a non-coaxial structure is connected to the outer conductor, and in which the outer conductor is concentrically with the center conductor.

### TECHNICAL FIELD

The present disclosure relates to a coaxial cable unit in which an electric signal input through the input side is transmitted to the output side, and a connector of a non-coaxial structure is attached to a center conductor and an outer conductor in the output side, and also to a transmission circuit using the coaxial cable unit. More particularly, the present disclosure relates to a coaxial cable unit in which, even when a non-coaxial connector is used in the output side of a coaxial cable, the noise resistant characteristics are improved, and also to a transmission circuit using the coaxial cable unit.

### RELATED ART

A coaxial cable transmits an electric signal input through one end (input side), to the other end (output side). While suppressing influences of electrical noises from an external source, the coaxial cable can efficiently and satisfactorily transmit the electric signal over a wide frequency band from DC to the high frequency. Therefore, the coaxial cable is used not only in transmission between electronic components/circuit boards in an apparatus, but also in various other places as a cable for connecting apparatuses to each other.

Such a coaxial cable is configured by, in a concentric manner from the center toward the outside, a core wire (center conductor), an insulator, a shield member (outer conductor) formed by braiding a thin conductor, and an insulator (protective cover). These portions form the sectional shape of the cable into a concentric shape. In a usual use, an electric signal is transmitted through the center conductor, and the outer conductor is connected to a common potential (the ground potential).

In a waveform measuring apparatus (for example, a digital oscilloscope, or a logic analyzer), a probe which is to be connected physically and electrically to an object to be measured to transmit an electric signal obtained from the object to be measured to the main unit of the waveform measuring apparatus is necessary (for example, see Patent Reference 1).

In a probe for a waveform measuring apparatus, usually, an electric signal which is input to a tip end portion (a portion which is connected physically and electrically to the object to be measured) of the probe is first amplified by an amplifying portion that is separated from the tip end portion by several [cm] to several tens [cm], and then transmitted to the main unit of the waveform measuring apparatus, or in some cases an electric signal is directly transmitted from the tip end portion to the main unit of the waveform measuring apparatus.

A coaxial cable is disposed between, for example, the tip end portion and the amplifying portion, the amplifying portion and the main unit, or the tip end portion and the main unit, and used for transmitting the electric signal of the object to be measured.

A coaxial connector in which the center conductor is shielded is used in the output side of the coaxial cable, and connected to an electrical circuit of the transmission destination, so that the noise resistant characteristics are ensured.

In the waveform measuring apparatus, by contrast, it is usual to measure electric signals of a plurality of objects to be measured, and therefore the electric signals are transmitted by using a plurality of coaxial cables (for example, see Patent Reference 2).

When coaxial connectors are used respectively for all of the coaxial cables, there arises a problem in that the size of the circuit board of the transmission destination is hardly reduced. In the case of coaxial connectors, there is a further problem in that the connectors cannot be collectively inserted or removed. In such a case, sometimes, a multi-polar pin connector is mounted on the circuit board of the transmission destination, and a connector of a non-coaxial structure is attached to the output side of the coaxial cable.

FIG. 4 is a view showing the configuration of transmission of an electric signal by a related-art coaxial cable (an example in which a connector of a non-coaxial structure is used in the output side).

Referring to FIG. 4, a signal source 1 outputs an electric signal which is an object to be transmitted. In the case where the cable is connected to a waveform measuring apparatus, the signal source 1 outputs an electric signal which is an object to be measured. An external noise source 2 outputs a signal functioning as noises, aside from the electric signal of the signal source 1.

A coaxial cable 3 is configured by, starting from the center, a center conductor 3a, an insulator 3b, an outer conductor 3c, and a protective cover 3d, and transmits an electric signal which is input from the signal source 1 to one end (input side), to the other end (output side).

The input side of the coaxial cable 3 is connected to the signal source 1. The input side of the outer conductor 3c is connected to the reference potential side of the signal source 1.

A ferrite bead 4 has a shape such as a cylindrical shape, a spherical shape (having a through hole), or a ring-like shape. The coaxial cable 3 is passed through the hollow portion (through hole) of the ferrite bead 4. The ferrite bead 4 is disposed in the vicinity of the other end (output side) of the coaxial cable 3. In the example, although depending on the sizes of the coaxial cable 3 and the ferrite bead 4, and the like, the term “vicinity” means a range of from several [mm] to ten and several [cm], and, in the case of a probe for a waveform measuring apparatus, means a range of from several [mm] to several [cm].

A circuit board 5 corresponds to the amplifying portion or the input portion of the above-described waveform measuring apparatus, and has a signal conductor wiring 5a, a load resistor 5b, and board connectors 5c, 5d. Various electronic components are mounted on the circuit board. The board connector 5c is connected to the signal conductor wiring 5a. The board connector 5d is connected to the ground potential of the circuit board 5. The load resistor 5b on the signal conductor wiring 5a matches and terminates the coaxial cable 3. The board connectors 5c, 5d are configured by a multi-polar pin connector.

A non-coaxial connector 6 of a non-coaxial structure electrically connects the coaxial cable 3 with the circuit board 5, and physically fixes the coaxial cable 3 to the circuit board 5. In the example, for example, the non-coaxial connector 6 has two terminals 6a, 6b.

When terminals of the board connectors 5; 5d of the circuit board 5 are male pins, for example, terminals of the non-coaxial connectors 6a, 6b for the coaxial cable 3 are female receptacles.

The non-coaxial connector 6a is connected to the output side of the center conductor 3a, so that the center conductor 3a and the signal conductor wiring 5a are electrically connected to each other through the board connector 5c. The non-coaxial connector 6b is connected to the output side of the outer conductor 3; so that the outer conductor 3c and the ground potential (for example, a ground plane) of the circuit board 5 are electrically connected to each other.

An inductance 6c is an inductance produced in the non-coaxial connector 6b.

The non-coaxial connector 6 of a non-coaxial structure has a connector structure where the outer conductor 3c of the coaxial cable 3 is not coaxial with the center conductor 3a, the center conductor 3a is exposed, and the outer conductor 3c does not exert an effect of shielding the center conductor 3a (for example, see Patent Reference 3).

The operation of the thus configured apparatus will be described.

The electric signal from the signal source 1 is transmitted through the center conductor 3a, to the signal conductor wiring 5a of the circuit board 5 via the connector 6a of the coaxial cable 3 and the connector 5c of the circuit board 5. By contrast, ideally, the reference potential of the signal source 1 is caused to be equal to the ground potential of the circuit board 5, by the outer conductor 3c. Actually, the outer conductor 3c has a resistance component, and hence a voltage drop is caused so that a potential difference is produced between the input and output sides of the outer conductor 3c.

The magnetic flux due to the current of the center conductor 3a, and that due to the current of the outer conductor 3c cancel each other, and hence the magnetic flux in the ferrite bead 4 due to the signal current of the electric signal flowing through the center conductor 3a becomes “0”. Therefore, the ferrite bead 4 exerts no influence on the transmission of the signal of the signal source 1.

Then, the operation in which noises due to the external noise source 2 enters the signal of the signal source 1 will be described.

The external noise source 2 is coupled to the outer conductor 3c of the coaxial cable 3 to cause a noise current Iᵣ to flow through the outer conductor 3c. The noise current Iᵣ flowing through the outer conductor 3c flows into the ground potential of the circuit board 5 via the inductance 6c of the connector 6b. Then, the noise current Iᵣ is converted to a noise voltage by the impedance of the inductance 6c.

The coaxial cable 3 can be deemed as a four-terminal network in which two terminals (the one end of the center conductor 3a and the one end of the outer conductor 3c) are in the input side, and two terminals (the other end of the center conductor 3a and the other end of the outer conductor 3c) are in the output side. In such a four-terminal network, the inductance 6c can be deemed to be series connected to the center conductor 3a in the output side (other end) of the coaxial cable 3. Therefore, the noise voltage appearing across the ends of the inductance 6c is added (entered) to the voltage of the signal appearing in the center conductor 3a in the output side of the coaxial cable 3, and then the voltage is input to the signal conductor wiring 5a of the circuit board 5.

The ferrite bead 4 causes the impedance of the outer conductor 3c in a portion to which the ferrite bead 4 is attached, to be increased, and hence has an effect of reducing the noise current Iᵣ. As a result, the noise voltage of the external noise source 2 is lowered by the ferrite bead 4.

In the portion of the coaxial cable 3 where the center conductor 3a is shielded by the outer conductor 3c (the portion where the outer conductor 3c is concentrically overlapped with the center conductor 3a), the entering of the noise voltage is negligible. This will be described below.

FIGS. 5A and 5B are views showing the in-phase voltage removal principle of the coaxial cable 3. FIG. 5B shows a cross-section of the coaxial cable 3 taken along a line I-I in FIG. 5A. In FIG. 5B, illustration of protective cover and ferrite bead is omitted. In the figure, the components which are identical with those of FIG. 4 are denoted by the same reference numerals, and their description is omitted.

The noise current Iᵣ flowing through the outer conductor 3c of the coaxial cable 3 produces a magnetic flux B1. The magnetic flux B1 completely interlinks with the center conductor 3a, and therefore generates a voltage which is equal in level to the voltage drop due to the floating inductance of the outer conductor 3c, in the center conductor 3a.

Therefore, the voltage of the signal of the signal source 1 appears across the ends of the load resistor 5b without being affected by the voltage of the noise source 2. For example, the voltage of the signal of the signal source 1 can be measured by a voltmeter V.

In the case where a resistance component exists in the outer conductor 3c, however, the voltage drop due to the resistance component is not induced in the center conductor 3a, and hence the in-phase voltage removal characteristics are lowered in the case of a low frequency. However, the in-phase voltage removal characteristics can be sufficiently obtained in the high-frequency band where the coupling of the external noise source 2 is enhanced.

In the case where the ferrite bead 4 is attached to the coaxial cable 3, even when a resistance component exists in the outer conductor 3c, the inductance of the outer conductor 3c can be increased while the resistance component remains as it is. Therefore, the in-phase voltage removal characteristics in the low-frequency band can be improved.

[Patent Reference 1] W-A-01-105173

[Patent Reference 2] JP-A-2003-227850

[Patent Reference 3] JP-A-0433-4877

As described above, when the ferrite bead 4 is disposed in the vicinity of the output side of the coaxial cable 3, the noise current and voltage from the external noise source 2 can be reduced.

However, the external noise source 2 is not physically directly connected to the outer conductor 3c, but propagates as an electromagnetic wave through the air having a very high impedance, to be coupled with the outer conductor 3c. The external noise source 2 which can be coupled has a very high voltage. Of course, the impedance of the air (space) is very higher than that of the outer conductor 3c to which the ferrite bead 4 is attached.

In the case where the external noise source 2 has a high voltage and external noises are coupled with the outer conductor 3c via a high impedance, even when the ferrite bead 4 is attached to the coaxial cable 3, the noise current Iᵣ cannot be hardly reduced. Therefore, there arises a problem in that the noise current Iᵣ cannot be reduced and an electric signal from the input side cannot be correctly transmitted to the output side.

When the frequency at which the outer conductor 3c of the coaxial cable 3 resonates (produces a standing wave) coincides with the frequency of external noises, the situation which is similar to that in the above-described case where the transmission is performed at a high voltage via a high impedance is produced, and the effect due to the disposition of the ferrite bead 4 is reduced.

In such a situation, namely, there is a problem in that noises are caused to enter the signal of the signal source 1 by the inductance 6c of the connector 6b in the side of a grounding wire (the side of the outer conductor 3c).

### SUMMARY

Exemplary embodiments of the present invention provide a coaxial cable unit in which, even when a non-coaxial connector is used in the output side of the coaxial cable, the noise resistant characteristics are improved, and also a transmission circuit using the coaxial cable unit.

(1) A coaxial cable unit according to an exemplary embodiment of the invention, comprises:

a coaxial cable having a center conductor and an outer conductor;

a connector of a non-coaxial structure that is attached to the center conductor and the outer conductor on an output side of the coaxial cable; and

a bypass wire that is connected to the outer conductor at a portion, which is on an input side with respect to a position where the connector of a non-coaxial structure is connected to the outer conductor, and in which the outer conductor is concentrically with the center conductor.

(2) The coaxial cable unit of (1) may further comprises a ferrite core that is attached between the output side of the coaxial cable and the portion to which the bypass wire is connected.
(3) In the coaxial cable unit of (1) or (2), an impedance of the bypass wire may be lower than an impedance of a path which, in a path of the outer conductor, extends from the portion to which the bypass wire is connected, to the connector of a non-coaxial structure.
(4) A transmission circuit according to an exemplary embodiment of the invention comprises:

a coaxial cable unit according to any one of (1) to (3); and

a circuit board having a board connector to which the connector of a non-coaxial structure of the coaxial cable unit is connected, and a bypass connector to which the bypass wire is connected.

(5) In the transmission circuit of (4), the coaxial cable may be a multiple cable, and a plurality of terminals may be integrally formed in the board connector.

According to the invention, the following effects are attained.

According to (1) to (3) above, the bypass wire is connected to the outer conductor of the portion where the shielding for the center conductor is ensured. Even when external noises are coupled to the outer conductor of the coaxial cable and a noise current flows through the outer conductor, therefore, most of the noise current flows via the bypass wire. As a result, a noise voltage which is generated across the ends of an inductance produced in the connector of a non-coaxial structure is largely lowered, and is not added to an electric signal output from the output side of the center conductor. Even a non-coaxial connector is used in the output side of the coaxial cable, therefore, the noise resistant characteristics are improved.

According to (4) and (5) above, the coaxial cable according to any one of (1) to (3) is used, the bypass connector is disposed at a position of the circuit board which is different from the position of the board connector, and the bypass wire is connected to the bypass connector. Even when a large noise current from the bypass wire flows into the bypass connector, therefore, it is possible to prevent the large noise current from entering the signal transmitted by the center conductor, and the noise resistant characteristics are improved. Other features and advantages may be apparent from the following detailed description, the accompanying drawings and the claims.

### BRIEF DESCRIPTION OF THE DRAWINGS

FIG. 1 is a diagram showing a first embodiment of the invention.

FIG. 2 is a diagram showing a second embodiment of the invention.

FIG. 3 is a view showing an example of the appearance of a probe for a waveform measuring apparatus using the embodiment of FIG. 2.

FIG. 4 is a view showing the configuration of a related-art transmission circuit.

FIGS. 5A and 5B are views showing the in-phase voltage removal principle of a coaxial cable 3.

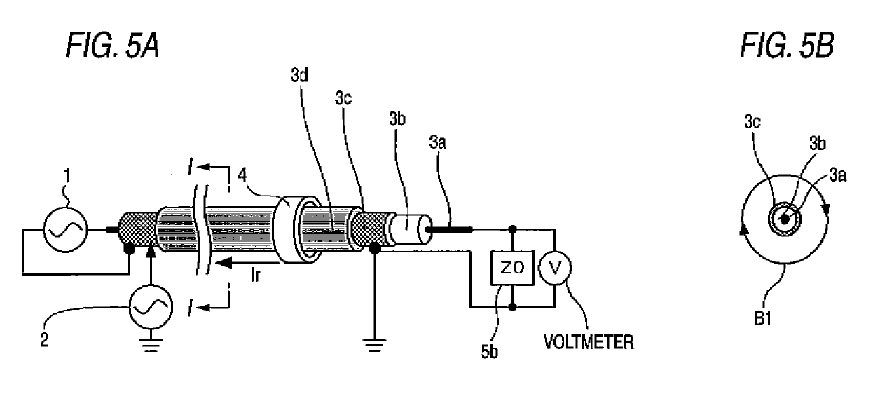

### DETAILED DESCRIPTION

Hereinafter, an embodiment of the invention will be described with reference to the drawings.

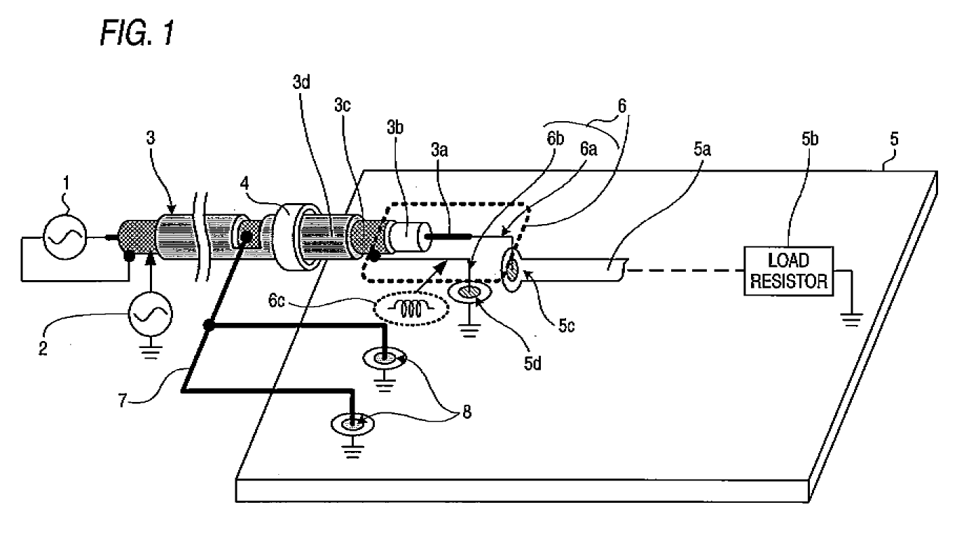

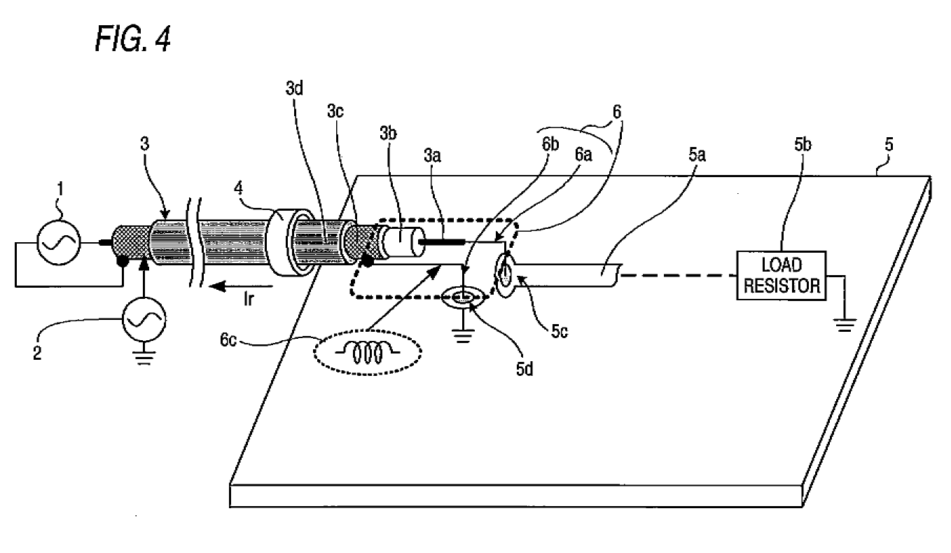

FIG. 1 is a diagram showing an embodiment of the invention. In the figure, the components which are identical with those of FIG. 4 are denoted by the same reference numerals, and their description is omitted.

Referring to FIG. 1, a bypass wire 7 which is a metal conductor (for example, the material is copper, and the wire kind is a solid wire, a stranded wire in which solid wires are bundled, or the like) is disposed in the coaxial cable 3. A bypass connector 8 for connecting the bypass wire 7 to a common potential of the circuit board 5 is disposed on the circuit board 5 (in FIG. 1, two bypass connectors are disposed).

One end of the bypass wire 7 is connected to the outer conductor 3c in the vicinity of the ferrite bead 4 (the one end is close to the input side of the coaxial cable 3 with respect to the position where the ferrite bead 4 is attached (in a distance range of from several [mm] to several [cm])). In the portion of the coaxial cable 3 to which the bypass wire 7 is connected, only the protective cover 3d is peeled off, and the outer conductor 3c is not peeled off, so that the center conductor 3a is shielded by the outer conductor 3c. Namely, the non-coaxial connector 6, the ferrite bead 4, and the connecting portion of the bypass wire 7 are arranged in this sequence along the longitudinal direction of the coaxial cable 3.

The other end of the bypass wire 7 is connected to the common potential of the circuit board 5 via the bypass connector 8. The pin (terminal) of the bypass connector 8 is disposed in a place on the circuit board 5 which is physically different from that of the terminals of the board connector 5d. Particularly, the bypass connector 8 is disposed at a position which is separated from the board connector 5c for signal transmission, and the signal conductor wiring 5a.

In FIG. 1, the single bypass wire 7 which is connected to the one end side (the side where the outer conductor 3c is connected) is branched into two wires in the middle of the bypass wire, and the other ends of the branch wires are connected to the bypass connectors 8.

The coaxial cable unit according to an exemplary embodiment of the present invention is configured by at least the coaxial cable 3, the non-coaxial connector 6 (6a, 6b) which is attached to the output side of the coaxial cable 3, and the bypass wire 7 (which is connected and fixed to the portion of the outer conductor 3c which is on the input side with respect to the position where the non-coaxial connector 6 of a non-coaxial structure is connected to the outer conductor 3c, and in which the outer conductor 3c is concentrically overlapped with the center conductor 3a).

The transmission circuit according to an exemplary embodiment of the present invention is configured by at least the circuit board 5, the board connectors 5c, 5d on the circuit board 5, and the bypass connectors 8, in addition to the coaxial cable 3, the non-coaxial connector 6 (6a, 6b), and the bypass wire 7.

The operation of the thus configured apparatus will be described. The operation of transmitting the electric signal from the signal source 1 to the circuit board 5 through the center conductor 3a is identical to that of the related-art coaxial cable, and hence its description is omitted.

The operation in which noises due to the external noise source 2 enter the signal of the signal source 1 will be described.

The external noise source 2 is coupled to the outer conductor 3c of the coaxial cable 3 to cause the noise current Iᵣ to flow through the outer conductor 3c. Most of the noise current Iᵣ flowing through the outer conductor 3c flows through the bypass wire 7, and flows into the ground plane of the circuit board 5 via the bypass connectors 8.

Namely, the impedance of the portion of the outer conductor 3c to which the ferrite bead 4 is attached is increased by the ferrite bead 4. Therefore, the noise current Iᵣ does not substantially flow through the path (the attached portion of the outer conductor 3c—the non-coaxial connector 6b—the board connector 5d) on the side of the coaxial cable 3 to which the ferrite bead 4 is attached, and flows through the path on the side of the bypass wire 7 in which the impedance is low.

Therefore, the noise current Iᵣ flowing through the inductance 6c of the non-coaxial connector 6b on the side of the outer conductor 3c (on the side of the grounding wire) is largely reduced, also the noise voltage appearing across the ends of the inductance 6c is largely lowered, and is not added to the electric signal output from the output side of the center conductor 3a (the electric signal which is transmitted from the signal source 1 to the center conductor 3a).

As described above, the one end of the bypass wire 7 is connected to the outer conductor 3c on the input side with respect to the portion to which the ferrite bead 4 is attached, and the other end is connected to the bypass connector 8. Therefore, the noise current Tᵣ from the external noise source 2 does not flow through the path (the attached portion of the outer conductor 3c—the non-coaxial connector 6b—the board connector 5d) in which the impedance is increased by the attachment of the ferrite bead 4, but flows through the bypass wire 7 in which the impedance is lower than that of the attached portion of the outer conductor 3c. Therefore, the noise voltage appearing across the ends of the inductance 6c is largely lowered, and is not added to the electric signal output from the output side of the center conductor 3a. Even when a non-coaxial connector is used in the output side of the coaxial cable, therefore, the noise resistant characteristics are improved.

Furthermore, the bypass connector 8 is disposed at the position which is separated and different from the board connector 5d and the signal conductor wiring 5a on the circuit board 5. Even when the noise current Iᵣ of a large level flows from the bypass wire 7 into the connector 8, therefore, it is possible to prevent the large noise current Iᵣ from entering the signal conductor wiring 5a, and the noise resistant characteristics are improved.

For example, the coaxial cable 3 shown in FIG. 1 was applied to a logic probe of a waveform measuring apparatus, and an EMC (MHz-band radiation electromagnetic field immunity test) was performed on the probe. A probe to which a coaxial cable using only the ferrite bead 4 is applied did not pass the EMC test because of a resonant frequency according to the length of a tip end harness portion. By contrast, a probe to which the coaxial cable shown in FIG. 1 is applied passed the test.

The invention is not restricted to the embodiment, and may be configured in the following manners.

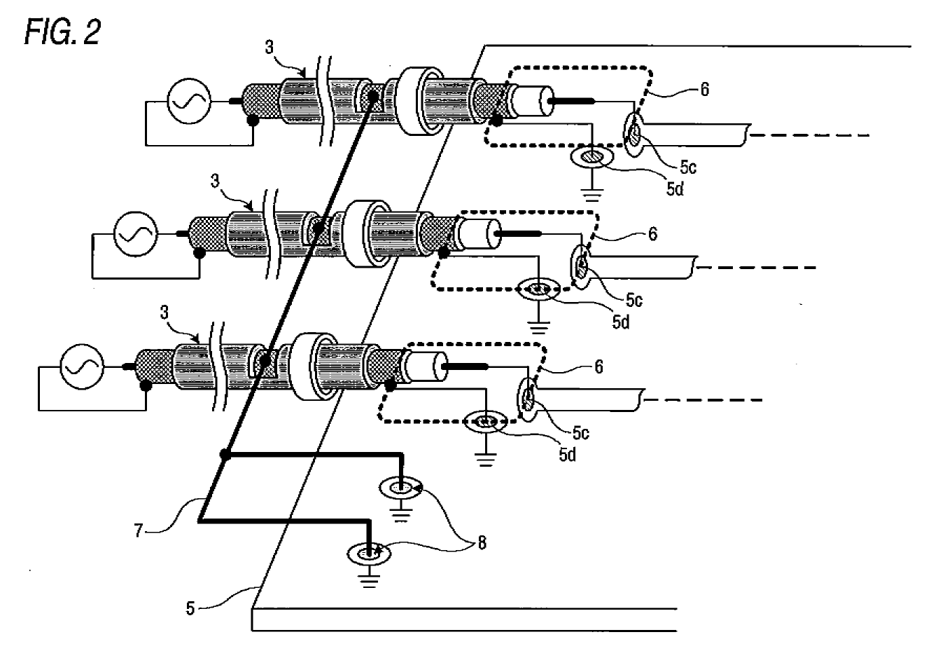

(1) In the circuit shown in FIG. 1, the configuration which uses the single coaxial cable 3 has been shown. Alternatively, signals from a plurality of signal sources 1 may be transmitted to the same circuit board 5 by a plurality of coaxial cables. In the alternative, the bypass wire 7 may be disposed for each of the coaxial cables 3, or the plural coaxial cables 3 may share the bypass wire 7. FIG. 2 shows an example in which the bypass wire 7 is configured as a wire common to the plurality of coaxial cables 3, and connected to the portion of the outer conductor 3c in the vicinity of the ferrite bead 4 for each of the coaxial cables 3 (on the input side (the side of the signal sources 1) with respect to the position to which the ferrite bead 4 is attached).

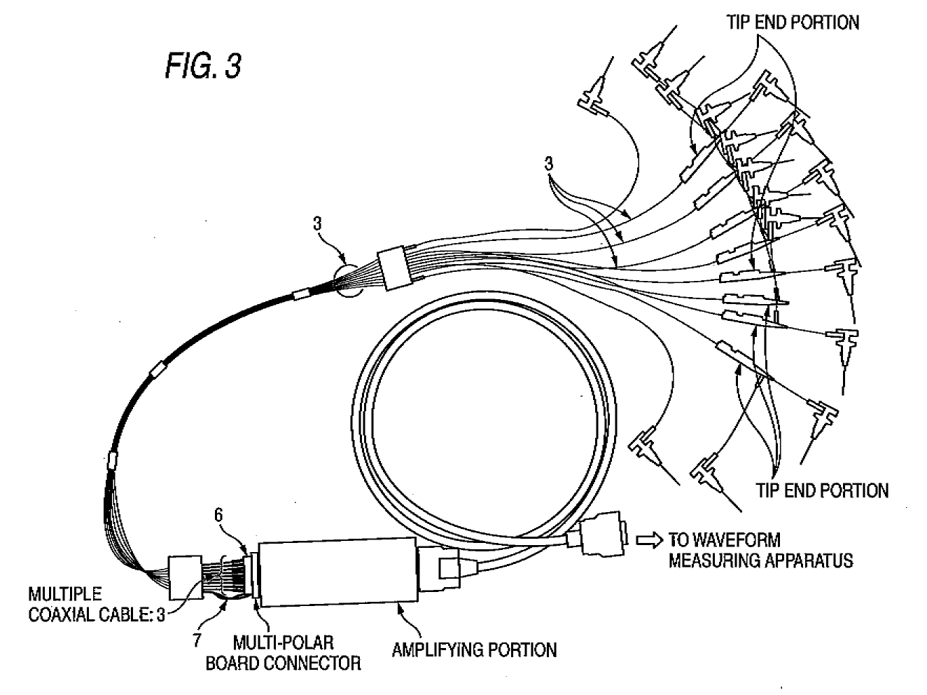

FIG. 3 is a view showing an example of a logic probe for a waveform measuring apparatus using a plurality of coaxial cables. In a waveform measuring apparatus such as a high-speed logic analyzer shown in FIG. 3, particularly, there are many tip end portions (portions which are to be physically connected to signal sources of an object to be measured), and electric signals are transmitted to the amplifying portion or the main unit of the waveform measuring apparatus while collecting the plurality of probes.

Ideally, a coaxial connector is used in the output side of a coaxial probe of the waveform measuring apparatus. However, a coaxial connector is larger and more expensive than a non-coaxial connector. In the case where the output sides of a multiple coaxial cable such as shown in FIG. 3 are connected to the circuit board 5 by using a durable multiple coaxial connector, particularly, the other end of the coaxial cable 3 becomes large, and the circuit board 5 becomes large and very expensive.

By contrast, when the side of the circuit board 5 is configured by a multi-polar pin connector (a connector in which a plurality of pin terminals are integrally formed) which is highly durable, small in size, and inexpensive, and the bypass wire 7 is disposed in the coaxial cable 3 using the non-coaxial connector 6, the circuit board can be made small in size and inexpensive while ensuring durability. As compared with the case where the coaxial cable 3 is single, in the case where a plurality of coaxial cables are used and the non-coaxial connector 6 and the multi-polar board connectors 5c, 5d are employed, the effects of cost reduction and miniaturization are large.

(2) In the circuit shown in FIG. 1, the configuration where the single bypass wire 7 connected to the outer conductor 3c is branched into two wires in the other end side, and the other ends of the wires are connected to the bypass connectors 8 has been shown. For example, only one bypass connector 8 may be used, and the single (a stranded wire, or a solid wire) bypass wire 7 may be connected without being branched, or the connection may be performed by bypass wires 7 which are physically plural. Alternatively, a plurality of bypass connectors 8 may be disposed on the circuit board 5, one ends of plural bypass lines may be connected to the outer conductor 3c, and the other ends may be connected to the bypass connectors 8, respectively. Namely, the numbers of the bypass connector(s) 8 and the bypass wire(s) 7 are not particularly restricted, and their connection may be performed in an arbitrary manner. As the numbers of the bypass connectors 8 and the bypass wires 7 are larger, the impedance of the path on the side of the bypass wires 7 is further reduced, and the noise resistant characteristics are more improved. In this case, however, the installation area is increased and the size is enlarged. Therefore, they may be disposed in view of the impedance, the grounding area on the circuit board 5, and the like.
(3) The configuration where the terminals of the board connectors 5c, 5d of the circuit board 5 and the bypass connector 8 are male pins, and those of the non-coaxial connector 6 for the coaxial cable 3 are female receptacles has been described. Alternatively, the board connectors 5c, 5d and the bypass connector 8 may be configured as a female receptacle, and the non-coaxial connector 6 may have male pins.
(4) Although the configuration where the ferrite bead is used as one kind of a ferrite core has been described, a ferrite core of any kind and shape may be used. Namely, it is requested to configure a closed magnetic circuit by clamping the coaxial cable 3 with a magnetic member. For example, a plurality of through holes are disposed in a flat plate of a magnetic material, and a multiple coaxial cable such as shown in FIG. 3 may be passed through the respective through holes. Alternatively, a multiple coaxial cable may be clamped by two flat plates (having a substantially L- or U-like sectional shape).
(5) Although the configuration where the coaxial probe and transmission circuit shown in FIG. 1 are used in the probe of the waveform measuring apparatus has been described, they may be used between any kinds of apparatuses, electronic components, and the like. Particularly, they are preferably used in connection between circuits or apparatuses in which a potential difference exists between the common potentials of the transmission origin and destination.
(6) When the non-coaxial connector 6 of a non-coaxial structure is used in the output side of the coaxial cable 3, the characteristic impedance of the transmission path sometimes fails to match the coaxial cable 3. Such a characteristic impedance may be caused to match the cable in a frequency range (for example, a band required in a probe of a waveform measuring apparatus) from DC to several hundreds [MHz], by disposing a compensating circuit on the circuit board 5.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A coaxial cable unit comprising:
a coaxial cable having a center conductor and an outer conductor;
a connector of a non-coaxial structure that is attached to the center conductor and the outer conductor on an output side of the coaxial cable; and
a bypass wire that is connected to the outer conductor at a portion, which is on an input side with respect to a position where the connector of a non-coaxial structure is connected to the outer conductor, and in which the outer conductor is concentrically with the center conductor.

2. A coaxial cable unit according to claim 1, further comprising:
a ferrite core that is attached between the output side of the coaxial cable and the portion to which the bypass wire is connected.

3. A coaxial cable unit according to claim 1, wherein an impedance of the bypass wire is lower than an impedance of a path which, in a path of the outer conductor, extends from the portion to which the bypass wire is connected, to the connector of a non-coaxial structure.

4. A coaxial cable unit according to claim 2, wherein an impedance of the bypass wire is lower than an impedance of a path which, in a path of the outer conductor, extends from the portion to which the bypass wire is connected, to the connector of a non-coaxial structure.

5. A transmission circuit comprising:
a coaxial cable unit according to claim 1; and
a circuit board having a board connector to which the connector of a non-coaxial structure of the coaxial cable unit is connected, and a bypass connector to which the bypass wire is connected.

6. A transmission circuit according to claim 5, wherein the coaxial cable unit has a ferrite core that is attached between the output side of the coaxial cable and the portion to which the bypass wire is connected.

7. A transmission circuit according to claim 5, wherein
the coaxial cable is a multiple cable, and
a plurality of terminals are integrally formed in the board connector.

8. A transmission circuit according to claim 5, wherein
the coaxial cable unit has a plurality of the coaxial cables, and
the bypass wire is connected to each of the outer conductors of the coaxial cables.
